(19) United States
(12) Patent Application Publication
(10) Pub. No.: US 2011/0282606 A1
(43) Pub. Date: Nov. 17, 2011

(54) Scalable capacitive touch system and method

(76) Inventors: Jameel Abdul Ahed, Cape Coral, FL (US); Siddhartha Eluppai Srivatsan, Cape Coral, FL (US)

(21) Appl. No.: 13/068,606

(22) Filed: May 16, 2011

Related U.S. Application Data
(60) Provisional application No. 61/395,604, filed on May 14, 2010.

(51) Int. Cl. G06F 19/00

(52) U.S. Cl. 702/65

(57) ABSTRACT

A scalable capacitive touch system includes a header unit having a processor, an internal communication unit, and an external communication unit adapted to communicate button identification data to an external device; and at least one adder unit. Each adder unit can include at least one capacitive pad, a controller for monitoring the at least one capacitive pad, and a communication interface adapted, to communicatively connect to at least one of the header unit and another adder unit, and to communicate button actuation data to the header unit for processing by the processor to identify a user-activated capacitive pad.

### CROSS-REFERENCE TO RELATED DOCUMENTS

This disclosure claims the priority of, and incorporates by reference in its entirety, U.S. Provisional Patent Application Ser. No. 61/395,604, filed on May 14, 2010 by AHED et al.

### BACKGROUND OF THE INVENTION

Capacitive touch systems and methods can be used to measure changes in capacitance of pads to determine if a user selects an input associated with a particular pad.

### SUMMARY OF THE INVENTION

It is therefore, an object of the present invention to provide a scalable capacitive touch system and method.

In an exemplary embodiment, the present invention can be embodied in a scalable capacitive touch system that includes a header unit having a processor, an internal communication unit, and an external communication unit adapted to communicate button identification data to an external device; and at least one adder unit. In an exemplary aspect, each of the at least one adder unit can include at least one capacitive pad, a controller for monitoring the at least one capacitive pad, and a communication interface adapted, to communicatively connect to at least one of said header unit and another adder unit, and to communicate button actuation data to said header unit for processing by the processor to identify a user-activated capacitive pad.

In another exemplary embodiment, the present invention can be embodied in a scalable capacitive touch system and method, which can include multiple segments having respective controllers, at least one pad connected thereto, and a respective communication interface for communicatively connecting segments. At least one segment can further include an interface for connecting to an external device, such as a computer or other electrical device for processing of signals provided by the at least one segment.

Additionally, the present invention can be embodied in a method corresponding to an exemplary system, as described further herein.

### BRIEF DESCRIPTION OF THE DRAWINGS

The present invention is illustrated by way of example, and not in limitation, in the figures of the accompanying drawings, in which:

FIG. 1 illustrates an exemplary scalable capacitive touch system that includes a header unit 110 having a processor 112, an internal communication unit 114, and an external communication unit 116; and at least one adder unit 120ᵢ.

FIG. 2 illustrates another exemplary scalable capacitive touch system having a header unit 210, at least one adder unit 220i, and a communication/power line or bus network 240.

### DETAILED DESCRIPTION OF THE INVENTION

The invention will now be described in more detail by way of example with reference to the embodiments shown in the accompanying figures. It should be kept in mind that the following described embodiments are only presented by way of example and should not be construed as limiting the inventive concept to any particular physical configuration, shape, size, or order, or employing any particular communication means.

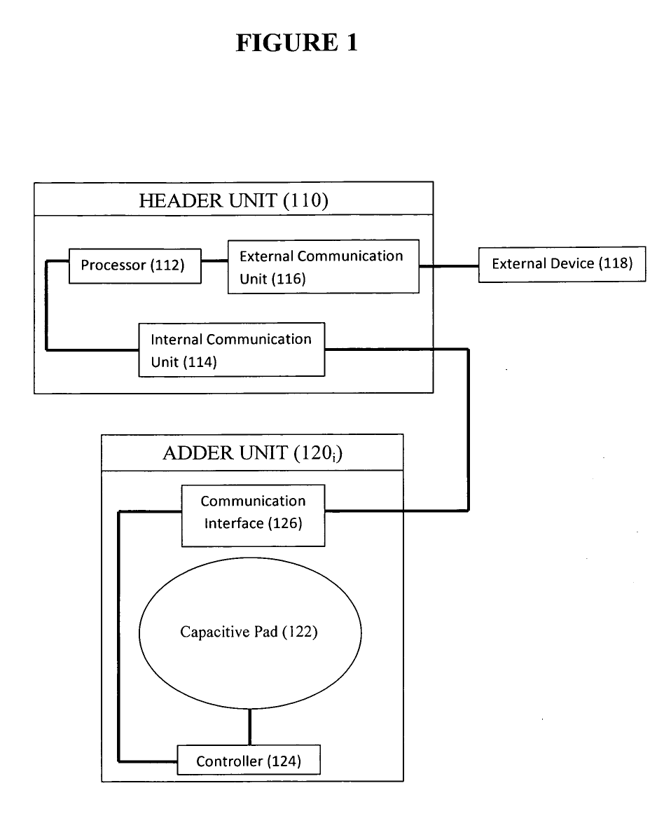

FIG. 1 illustrates an exemplary embodiment of the present invention, in which a scalable capacitive touch system can include a header unit 110 having a processor 112, an internal communication unit 114, and an external communication unit 116 adapted to communicate button identification data to an external device 118; and at least one adder unit 120ᵢ.

As exemplary aspects of the present invention, each of the at least one adder unit 120ᵢ can include at least one capacitive pad 122, a controller 124 for monitoring the at least one capacitive pad, and a communication interface 126 adapted, to communicatively connect to at least one of said header unit 110 and another adder unit (not shown), and to communicate button actuation data to said header unit 110 for processing by the processor 112 to identify a user-activated capacitive pad (not shown).

As enabled hereby, the present invention can provide a single design scheme that advantageously allows a capacitive touch interface to be easily and conveniently created in plural configurations to conform to myriad different applications and/or environments. In particular, either one or more adder units 120ᵢ can be selectively combined to form a single capacitive interface of a particular size, length, layout, and/or function.

In an exemplary aspect, the present invention provides a scalable capacitive touch system having a plurality of segments, with each segment having a respective controller, at least one pad connected thereto, and a respective communication interface for communicatively connecting to another segment. At least one segment further includes an interface for connecting to an external device, such as a computer or other electrical device for processing of signals provided by the at least one segment.

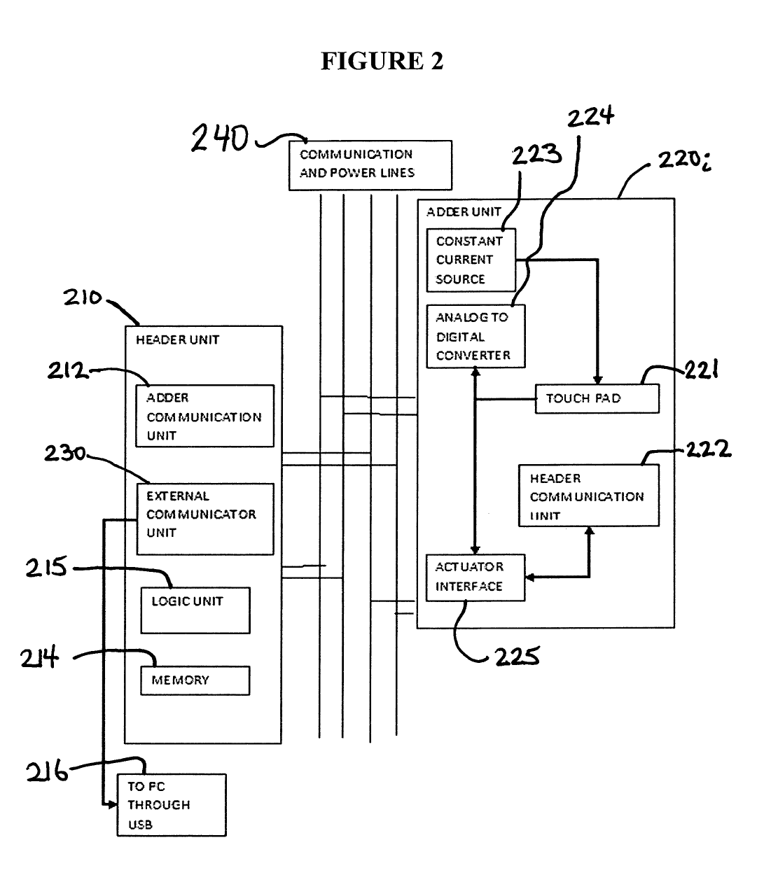

FIG. 2 illustrates yet another exemplary embodiment of the present invention, in which a system can be constructed from one or more building blocks; namely, a header unit 210, an adder unit 220ᵢ, and an external communicator unit 230. Header unit 210 can be responsible for communicating with the adder unit 220ᵢ through an adder communication unit 212 and for collecting button press data. Further, header unit 210 can process collected button press data and can choose one of them as representing a button that was intended to be activated by a user. External communicator unit 230 can communicate identifying data, such as a position, for example and not in limitation, corresponding to a capacitive touch button to an external device, if a respective button press data was selected by header unit 210. A single adder unit 220ᵢ can include a plurality of capacitive pads or touch pads 221 that can form a scalable slider interface.

In an exemplary aspect, contact with, or close proximity to, a capacitive pad by an ionic object, such as a human hand or finger, for example and not in limitation, adder unit 220ᵢ can generate an actuation signal and button press data. Adder unit 220ᵢ can also consist of a header communication unit 222 through which requests for button press data and commands to turn off the actuation signal (if the respective button press data are not the analog to digital converter 224 can be provided independently, in whole or in part, of such a computer, such as a micro-controller, for example and not in limitation.

Actuator interface 225 can perform one or more functions to the extent desired, such as monitoring one or more pads 221 over a period of time to obtain respective time-discrete button values, with the values being stored in a memory 214, such as in a sorted order, for example and not in limitation. The order can be based on button values from the lowest value to the highest value, for example and not in limitation. An actuator interface 225 can compare an intermediate button value to a reference button value associated with the capacitive touch pad 221. Finally, an actuation signal associated with the capacitive touch pad 221 can be provided, if a difference between the intermediate and reference values exists. In an embodiment where plural capacitive touch pads 221 are provided in adder unit 220ᵢ, multiple actuation signals can be generated. In such cases, the actuation signal produced can be associated with a capacitive touch pad 221ᵢ, if the respective difference between the intermediate value and reference value is the highest.

Any digital and/or analog filtering technique can be utilized to enhance detection.

An actuator interface 225 can also produce button press data during actuation. In an exemplary embodiment, button press data can consist of two parts: a difference between an intermediate button value and a reference button value associated with the respective capacitive touch pad for which the actuator interface of the adder unit is generating an actuation signal; and a position code corresponding to the capacitive touch pad pressed. If the adder unit 220ᵢ includes only one capacitive touch pad 221, the position code can indicate the adder unit of which the capacitive touch pad is a part. If the adder unit 220ᵢ has a plurality of capacitive touch pads 221, a position code can indicate the relative position of the respective capacitive touch pad 221 within the respective adder unit.

In another embodiment, the present invention can be embodied in a method corresponding to the teachings described above, as well as a computer program product including computer instructions for carrying out such a method.

In still yet another exemplary embodiment, header unit 210 can include an adder communication unit 212, a memory 214, and a logic unit 215. An adder communication unit 212 can be a standard peripheral such as UART, SPI, IIC, USB etc., for example and not in limitation, capable of communicating to the adder unit. With an adder communication unit 212, header unit 210 can monitor button press data of one or more adder units 220ᵢ. The memory 214 can store button press data generated by the actuator interface 225 of the adder unit 220ᵢ. The logic unit 215 can process button press data and select the position of one or more capacitive touch pads 221. In yet a further exemplary aspect, a button press corresponding to the capacitive touch pad 221 in the farthest adder unit 220ᵢ can be selected, and in another exemplary aspect, a capacitive touch pad 221 can be selected if the respective difference between an intermediate value and a reference value is the highest. The former aspect can provide greater speed, while the latter can provide enhanced accuracy.

In yet another exemplary embodiment, an adder communication unit 212 and memory 214 can be provided in a single computer and the logic unit 215 can be a computer program product stored on a computer readable medium.

An external communicator unit 230 capable of communicating the position code to an external device 216, which could be a personal computer, or another embedded system, can be provided. Such an external communicator unit 230 can include one or more of SPI, IIC, USB, UART, etc., for example and not in limitation, and can depend on the external devices 216 to which it is intended to be connected.

In another embodiment, an external communicator unit 230 can be present in the same computer as a header unit 210, and can be communicatively connected to a PC through a USB interface, for example and not in limitation.

As further illustrated in FIG. 2, a bus network 240 can be used to connect one or more header units to one or more adder units. Such a bus network 240 can include two lines that can represent Tx and Rx lines of a communication interface; but notably, can be effectuated in alternative embodiments. An embodiment using an Inter Integrated communication interface defining two lines as SDA and SCL is feasible. Further, embodiments featuring three or more lines are feasible.

It will be apparent to one of ordinary skill in the art that the manner of making and using the claimed invention has been adequately disclosed in the above-written description of the exemplary embodiments and aspects taken together with the drawings.

It should be understood, however, that the invention is not necessarily limited to the specific embodiments, aspects, arrangement, and components shown and described above, but may be susceptible to numerous variations within the scope of the invention.

Accordingly, the specification and drawings are to be regarded in an illustrative and enabling, rather than a restrictive, sense.

Therefore, it will be understood that the above description of the embodiments of the present invention are susceptible to various modifications, changes, and adaptations, and the same are intended to be comprehended within the meaning and range of equivalents of the appended claims.

Therefore, we claim:

1. A scalable capacitive touch system, comprising:
a header unit having a processor, an internal communication unit, and an external communication unit adapted to communicate button identification data to an external device; and
at least one adder unit;
wherein each of the at least one adder unit includes at least one capacitive pad, a controller for monitoring the at least one capacitive pad, and a communication interface adapted, to communicatively connect to at least one of said header unit and another adder unit, and to communicate button actuation data to said header unit for processing by the processor to identify a user-activated capacitive pad.

2. A scalable capacitive touch system, comprising:
a plurality of capacitive touch segments;
wherein each segment includes at least one capacitive pad, a controller for monitoring the at least one capacitive pad, and a communication interface adapted to communicatively connect such the segment to another segment, and at least one of said plurality of segments includes an external communication unit adapted to communicate button press data to an external device.
